(19) United States
(12) Patent Application Publication
(10) Pub. No.: US 2021/0387902 A1
(43) Pub. Date: Dec. 16, 2021

(54) BEAM SPLITTER WITH PHOTOCATALYTIC COATING AND FABRICATION METHOD THEREOF

(71) Applicant: Hony Glass Technology Co., Ltd., NEW TAIPEI CITY (TW)

(72) Inventors: Wen-Liang Huang, New Taipei City (TW); Wei-Hong Wang, Taoyuan City (TW); Zhen-Feng Wang, Keelung City (TW); Wei-Houng Chen, New Taipei City (TW); Pei-Feng Sheu, Taoyuan City (TW)

(21) Appl. No.: 16/898,462

(22) Filed: Jun. 11, 2020

(51) Int. Cl. C03C 17/25; G02B 5/08; G02B 1/10; G02B 27/10

(52) U.S. Cl. CPC C03C 17/256; G02B 5/0816; G02B 1/10; C03C 2218/365; G02B 2207/109; C03C 2218/111; C03C 2218/32; G02B 27/1006

(57) ABSTRACT

A method for making a beam splitter with photocatalytic coating is disclosed. First, a TiO₂—SiO₂ sol, a SiO₂ sol, and an anatase TiO₂ preform sol are prepared. A glass substrate having two opposite surfaces is provided. The two opposite surfaces of the glass substrate is coated with the TiO₂—SiO₂ sol, the SiO₂ sol, and the anatase TiO₂ preform sol by dip-coating, thereby forming a coated glass substrate with a multi-layer optical coating on each of the two opposite surfaces. The multi-layer optical coating comprises a TiO₂—SiO₂ coating, a SiO₂ coating, and an anatase TiO₂ preform coating. The coated glass substrate is subjected to an anneal process. The coated glass substrate is cut, thereby forming the beam splitter with photocatalytic coating.

### BACKGROUND OF THE INVENTION

### 1. Field of the Invention

The present invention relates with Sol-Gel coatings on a glass substrate. In particular, the present invention relates to a beam splitter with photocatalytic and optical coatings and a fabrication method thereof.

### 2. Description of the Prior Art

The human eye has different sensitivity to light spectrum composed of three main color lights: red, green and blue. In dark, the response of human eye to red and green light is stronger than the blue light. An antiglare rearview mirror or a blue mirror can modulate the artificial light irradiated from the headlamps of rear vehicles to day light by reflection of the optical coating on blue mirror. About 60% of the blue light of the artificial light from lamps of rear cars is reflected by the blue mirror, which reduces the green and red light and make the driver to see more clearly from blue mirror modulation and sensitivity of the human eye. Therefore, the blue mirror can greatly reduce the glare of] the light from head lamp of rear coming car, to present a clear and natural scene, and will not cause glare to drivers driving at night, so as to reduce driving risks and increase driving safety.

Due to the limited sensitivity to the spectrum of the headlights from the following vehicles at night, the human eye be glared by eye's sensitivity, can [see] only part of the spectrum. It is means, the visible light that the human eye responses to is red, orange, yellow, green, blue light, etc., and the human eye has different sensitivity to individual colors. The light temperature of blue light is close to the day light temperature, and the light temperature of orange and yellow is lower than the day light temperature, so the sensitivity of the human eye to orange light and yellow light is higher, especially in low light environments. For example, orange and yellow flames can be seen from 20 to 30 meters away in low light environments.

The blue mirror reflects wavelengths in the red or green light is lesser extent than the blue light. The blue mirror is fabricated by sol-gel dip optical coatings on two side glass to make the reflector of the required spectrum by optical interference technology. With the reflection spectrum which can enhance the blue light reflection and weaken the reflection of green, yellow, orange and red light to a bit, so as to reduce glare caused by orange light and yellow light from the following vehicles, thus improving the safety of driving at night. Therefore, the rear-view mirror modulate the light of headlamps to blue light as the main peak of the reflected light is referred to as “blue mirror”. Since most car headlamps are halogen lamps, the spectrum is mainly orange-yellow light. The blue mirror can reduce the reflection of orange-yellow light and strengthen the blue light reflection to produce a dimming effect, thereby reducing glare.

Conventionally, the blue mirrors on the market are made by vacuum coating techniques, which can be divided into: 1. multi-layer optical interference blue light reflective coating; and 2. blue pigment as color coating on the chrome-coated glass. Due to the weak bonding of the blue color coating of the later, optical multilayer coatings are mainly used. However, blue mirrors fabricated by vacuum coating have poor corrosion resistance and high production costs.

Although, there are many prior arts or patents of optical coating on glass, but blue mirror used as a rearview mirror on automobile is less, such as; U.S. Pat. No. 4,673,248, Reflecting mirror for automobile, U.S. Pat. No. 4,805,989, Multi-layered back reflecting mirror, U.S. Pat. No. 4,921,331 Multi-layered mirror, U.S. Pat. No. 4,955,705 Multi-layered back reflecting mirror, and U.S. Pat. No. 7,887,201, Low glare rear view mirror for vehicles. Most of them are made by vacuum deposition, but less of them made by sol-gel dip coating with high efficient method.

Some photocatalytic coating glass made by photocatalyst solution coating on glass for self-cleaning glass, such as: U.S. Pat. Nos. 6,013,372 and 6,830,785, Method for photocatalytically rendering a surface of a substrate superhydrophilic, a substrate with a superhydrophilic photocatalytic surface, and method of making thereof, U.S. Pat. Nos. 6,447,123, 6,789,906; 6,816,297 and 6,991,339, Electro-optic device having a self-cleaning hydrophilic coating, U.S. Pat. No. 6,997,570, Reflecting mirror. U.S. Pat. No. 7,419,718 Solution for forming ultrahydrophilic photocatalyst film construct provided with the film and process for producing the same. U.S. Pat. No. 7,655,274 Combustion deposition using aqueous precursor solutions to deposit titanium dioxide coating; and U.S. Pat. No. 7,887,201, Low glare rear-view mirror for vehicles, but the above-mentioned prior art references are not for blue mirror.

### SUMMARY OF THE INVENTION

It is one object of the invention to provide a method for fabricating an antiglare photocatalyst beam splitter that is particularly suited for the applications of exterior rearview mirrors for automobiles and the like, in order to solve the above-mentioned prior art shortcomings or problems.

One aspect of the invention provides a method for fabricating a beam splitter with photocatalytic coating. A TiO₂—SiO₂ sol, a SiO₂ sol, and an anatase TiO₂ preform sol are prepared. A glass substrate having two opposite surfaces is provided. The two opposite surfaces of the glass substrate is dip-coated with the TiO₂—SiO₂ sol, the SiO₂ sol, and the anatase TiO₂ preform sol, thereby forming a coated glass substrate with a multi-layer optical coating on each of the two opposite surfaces. The multi-layer optical coating comprises a TiO₂—SiO₂ coating, a SiO₂ coating, and an anatase TiO₂ preform coating. The coated glass substrate is subjected to an anneal process. The coated glass substrate is cut, thereby thermal forming the beam splitter with photocatalytic coating.

According to some embodiments, the dip-coating the two opposite surfaces of the glass substrate comprises: immersing the glass substrate in the TiO₂—SiO₂ sol, the SiO₂ sol, or the anatase TiO₂ preform sol; withdrawing the glass substrate from the TiO₂—SiO₂ sol, the SiO₂ sol, or the anatase TiO₂ preform sol at a constant withdrawal speed as requirements of each sol coating ; and baking the glass substrate at 150-250° C.

According to some embodiments, the final anneal process is performed at 400-600° C.

According to some embodiments, the multi-layer optical coating has reflection at blue spectral region.

According to some embodiments, a thickness of the TiO₂ coating=blue light wavelength/(4×TiO₂ coating refractive index), a thickness of the SiO₂ coating=blue light wavelength/(4×SiO₂ coating refractive index), and a thickness of the TiO₂—SiO₂ coating=blue light wavelength/(4×TiO₂ —SiO₂ coating refractive index).

According to some embodiments, TiO₂—SiO₂ sol, the SiO₂ sol and the anatase TiO₂ preform sol use titanium alkoxide or silicon alkoxide as a precursor, and wherein the TiO₂—SiO₂ sol, the SiO₂ sol and the anatase TiO₂ preform sol are prepared by hydrolysis, condensation and peptization in alcohol solvent.

According to some embodiments, the TiO₂—SiO₂ sol, the SiO₂ sol and the anatase TiO₂ preform sol are prepared to impart anti-glare effect to an automobile rearview mirror made for the blue mirror, which avoids glare from a following vehicle headlight to a driver, by adjusting a reflectance of the blue mirror, and by adjusting a solid content ratio of the TiO₂—SiO₂ sol, the SiO₂ sol and the anatase TiO₂ preform sol between 1-0.

According to some embodiments, a SiO₂/TiO₂ solid content ratio in the TiO₂—SiO₂ sol ranges between 1-0, and wherein the blue mirror reflects blue light at 440 nm and a reflectance thereof is between 55-65%.

According to some embodiments, an ambient air temperature and humidity is controlled and the withdrawal speed is adjusted according to a solid content of each of aid TiO₂—SiO₂ sol, the SiO₂ sol and the anatase TiO₂ preform sol, and wherein the glass substrate is baked at 150-250° C. for 10 minutes, and annealed at 400-600° C. for 1.0 hour, such that a peak of a reflective spectrum of the multi-layer optical coating is at 440 nm.

According to some embodiments, a peak of a reflection spectrum of an optical coating of each of the TiO₂—SiO₂ sol, the SiO₂ sol and the anatase TiO₂ preform sol is at 440 nm after baking and annealing, and then each sol is laminated and coated according to this condition to make optical coating as: anatase TiO₂/SiO₂/ SiO₂—TiO₂/glass substrate/SiO₂—TiO₂/SiO₂/anatase TiO₂ for blue mirror with a blue light reflectance at 440 nm between 55-65%.

According to some embodiments, the anatase TiO₂ preform sol uses titanium alkoxide as a precursor, hydrolyzed and condensed in ethanol, peptized by HNO₃, so as to form the anatase TiO₂ preform sol, and wherein an anatase TiO₂ coating formed by the dip-coating, baking and annealing has photocatalytic, hydrophilic, and self-cleaning effects.

According to some embodiments, the anatase TiO₂/SiO₂/ SiO₂—TiO₂/glass substrate/SiO₂—TiO₂/SiO₂/anatase TiO₂ blue mirror has the anatase TiO₂ coating on its outer surface, so under ultraviolet rays of sunlight, it has photocatalyst effects comprising hydrophilic phenomenon, chemical redox reaction, sterilization, mildew prevention, self-cleaning, and decontamination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional diagram showing an exemplary coating structure of a photocatalyst beam splitter according to one embodiment of the invention.

FIG. 2 shows the reflection spectrum of various beam splitter coating structures.

FIG. 3 is a flow diagram showing an exemplary process flow of making a photocatalyst beam splitter according to one embodiment of the invention.

### DETAILED DESCRIPTION

In the following detailed description of the disclosure, reference is made to the accompanying drawings, which form a part hereof, and in which is shown, by way of illustration, specific embodiments in which the invention may be practiced. These embodiments are described in sufficient detail to enable those skilled in the art to practice the invention.

Other embodiments may be utilized and structural, logical, and materials changes may be made without departing from the scope of the present invention. Therefore, the following detailed description is not to be considered as limiting, but the embodiments included herein are defined by the scope of the accompanying claims.

The present invention pertains to a beam splitter such as a blue mirror with a photocatalytic coating and a manufacturing method thereof. In general, a glass substrate is subjected to a dip-coating process including sequentially immersing the glass substrate into TiO₂—SiO₂, SiO₂ and TiO₂ colloidal sol compositions to form multi-layer coatings on opposite surfaces of the glass substrate. Depending upon the optical requirements, various sol compositions are prepared. The coated glass substrate formed by dip-coating and baking processes may comprise a layered structure that may be represented by: TiO₂ (anatase)/SiO₂/SiO₂—TiO₂/glass substrate/SiO₂—TiO₂/SiO₂/TiO₂ (anatase). The coated glass substrate may be subjected to annealing, cutting, and bending with heat. In addition, a metal coating or glue may be formed or applied on the coated glass substrate, and the coated glass substrate may be mounted at a casing so as to form an exterior rearview blue mirror assembly for vehicles.

The vehicles emit exhaust, grease and particles when driving, and the ambient air contains various types of exhaust, grease and particles, which may fall on the surface of the vehicles and the exterior rearview mirror along with wind and rain. The grease and particles make the surface of the exterior rearview mirror become hydrophobic, and therefore the mirror surface is covered with rain droplets in rainy days, which make the vehicle driver difficult to clearly observe the environment on both sides of the vehicle through the exterior rearview mirror, which affects the safety of driving.

The sol compositions of TiO₂—SiO₂, SiO₂ and TiO₂ are prepared with alcohol solvent. Durable tri-layer, double-sided optical grade coatings are formed by double-sided dip-coating, baking and annealing on the glass substrate. Depending upon the requirements, high-reflection coatings with broadband reflection at blue, green or red color may be fabricated. The fabricated coated glass substrate with tri-layer, double-sided optical grade coatings is particularly suited for the applications of rearview mirrors for vehicles, which can reduce the amount of reflected light emanated from the following car on the road, which is reflected to the driver's eyes through dusty air and dust on the car window and the rearview mirror. Due to the low frequency of the light spectrum of the vehicle headlights, the incident light is prone to be scattering and absorbed by the window glass and rearview mirror glass. The reflection spectrum that enters the driver's eyes is mostly low-frequency red-yellow spectral region, so the eyes will be more likely to produce low-frequency red-yellow light glare to the rear car lights.

Conventional blue mirrors are mainly used in interior rearview mirrors, but not suitable for exterior rearview mirrors, which are disposed on the left and right sides of a vehicle. The present invention addresses this issue by providing the TiO₂ coating on the outer surface of the blue mirror glass, which contains a large amount of anatase TiO₂ structure. Such a blue mirror can produce a photocatalytic effect under the ultraviolet rays of sunlight and produce effects of super-hydrophilic phenomena, chemical oxidation and reduction, sterilization and mildew prevention, self-cleaning and decontamination. The present invention is particularly suited for the applications of exterior rearview mirrors disposed on both sides of a vehicle. In addition to the reduction of glare of the car headlights when driving at night, the mirror has a photocatalytic effect, which makes the mirror self-cleaning and hydrophilic. When driving on rainy days, the rain drops on the mirror surface form a water film because the mirror surface is hydrophilic, so that the driver in the car can clearly observe the environment on both sides of the car. Therefore, the driving safety is improved.

The present invention provides TiO₂ sol, which is anatase TiO₂ preform sol. The glass substrate is subjected to dip-coating in respective sol compositions to form coatings on both sides of the glass substrate. The glass substrate is immersed and baked three times with SiO₂—TiO₂, SiO₂ and anatase TiO₂ preform sol, thereby forming a TiO₂ (anatase)/SiO₂/SiO₂—TiO₂/glass plate/SiO₂—TiO₂/SiO₂/TiO₂ (anatase) tri-layer, sol-coated glass substrate, which has reflection at blue spectral region. The coated glass substrate with anti-glare effect may be applicable to the interior rearview mirrors, which provides the driver with a clear view of the rear environment. The coated glass substrate with anti-glare effect may be particularly applicable to the left and right exterior rearview mirrors of vehicles, which provides hydrophilic and anti-fog effects on rainy days, so that the driver can clearly see the side view vision of the environment.

The photocatalyst rearview blue mirror of the present invention has a TiO₂ coating on the outmost surface of the blue mirror, which is mainly of TiO₂ anatase structure. The photocatalyst effect is produced under the irradiation of sunlight and ultraviolet rays, and effects including: super-hydrophilic phenomenon, chemical oxidation and reduction, sterilization and mildew prevention, self-cleaning and decontamination can be provided. Therefore, the physical function of the product of the present invention is represented by the blue mirror in the optical coating, and the photocatalyst in the chemical function. Therefore, the present invention beam splitter with photocatalytic and optical coatings is also referred to as a “photocatalyst blue mirror”. If the application of sol optical coating products is expanded, it can be applied to photocatalyst optical coating products.

According to the embodiments of the invention, the coatings on the blue mirror can be formed by sol-gel dipping. The glass substrate is dip-coated by the sol-gel dipping method, and the coatings are symmetrical on both sides of the glass substrate. The double-sided symmetrical optical coating may be formed by the following steps. First, the glass substrate is treated by acid, alkaline, water and alcohol solution. The glass substrate is then washed in ultrasonic bath. After drying, the glass substrate is hung vertically on an arm of a lifter. The cleaned glass substrate is then vertically immersed in the sol. When the sol is stationary, the glass plate is withdrawn from the sol at a constant speed such that coating occurs due to the vertical flow of sol onto the elevated surface of the glass substrate. At the same time, the solvent in the sol evaporates. Alcohol evaporation and sol gelized reaction occurs because the water vapor in the air reacts with the alkoxide in the sol. As the glass substrate is withdrawn at a constant speed, the coating is bonded to the glass substrate at a constant speed to form a gelized film that is designated by “(g)”. After the aforesaid sol coating, the coated glass substrate is took off the lifter, placed in an oven, and then baked at 150-250° C. for about 10 minutes, thereby producing a baked coating, which is designated by “(b)”. Subsequently, the coated glass substrate is subjected to cooling for subsequent sol coating.

In order to fabricate the beam splitter with optical coating, the sol optical coating is performed as described above, and the TiO₂—SiO₂ sol coating is first performed to obtain TiO₂—SiO₂ (g)/Glass/TiO₂—SiO₂ (g) coated glass; and then baking is performed to obtain TiO₂—SiO₂ (b)/Glass/TiO₂—SiO₂ (b) coated glass.

Subsequently, SiO₂ sol coating is perform to coat the TiO₂—SiO₂ (b)/Glass/TiO₂—SiO₂ (b) coated glass, thereby forming SiO₂ (g)/TiO₂—SiO₂ (b)/Glass/TiO₂—SiO₂ (b)/SiO₂ (g) coated glass, and then baked to obtain SiO2 (b)/TiO2—SiO2 (b)/Glass/TiO2—SiO₂ (b)/SiO₂ (b) coated glass.

Subsequently, TiO₂ sol coating is perform to coat the SiO₂ (b)/TiO₂—SiO₂ (b)/Glass/TiO₂—SiO₂ (b)/SiO₂ (b) coated glass, thereby forming TiO₂ (g)/SiO₂ (b)/TiO₂—SiO₂ (b)/Glass /TiO₂—SiO₂ (b)/SiO₂ (b)/TiO₂ (g) coated glass, and then baked to obtain TiO₂ (b)/SiO₂ (b) /TiO₂—SiO₂ (b)/Glass/TiO₂—SiO₂ (b)/SiO₂ (b)/TiO₂ (b) coated glass.

Finally, the TiO₂ (b)/SiO₂ (b)/TiO₂—SiO₂ (b)/Glass/TiO₂—SiO₂ (b)/SiO₂ (b)/TiO₂ (b) coated glass is annealed at high temperatures or directly heated at 400-600° C., such that the baked coating is sintered into TiO₂ (A)/SiO₂ (a)/TiO₂—SiO₂ (a)/Glass/TiO₂—SiO₂ (a)/SiO₂ (a)/TiO₂ (A) coated glass, wherein “TiO₂ (A)” represents anatase TiO₂ and “(a)” represents “annealed” coating. As shown in FIG. 1, an exemplary photocatalyst blue mirror sol coating structure is illustrated. After subjecting the glass substrate 100 to the sol optical coating, baking and annealing, the first layer is TiO₂—SiO₂ amorphous coating 110, the second layer is SiO₂ amorphous coating 120, and the third layer is anatase TiO₂ coating 140 are formed. The anatase TiO₂ coating 140 is a photocatalyst layer. According to various embodiments, the TiO₂—SiO₂ coating (110) may have different SiO₂/TiO₂ ratios, for example, SiO₂/TiO₂ ratio=1/1, SiO₂/TiO₂ ratio=2/1, SiO₂/TiO₂ ratio=3/1, or SiO₂/TiO₂ ratio=4/1.

For the preparation of TiO₂—SiO₂ sol, silicon alkoxide Si(OR)₄ is first added to the alcohol solvent ROH. After stirring, it is mixed to form a silicon alkoxide solution. Ethanol EtOH can be used as the solvent. The silicon alkoxide used can be silicon ethoxide Si(OEt)₄, silicon methoxide Si(OMe)₄, silicon propoxide Si(OPr)₄, silicon isopropoxide Si (OPrⁱ)₄, or other silicon alkoxides. A mixture of H₂O:R₁OH=1:2 is prepared, and added dropwise into the stirred silicon alkoxide solution for Si(OR₂)₄ hydrolysis to obtain an alcohol solution of Si(OR₂)₃OH. Take the equivalent of titanium alkoxide Ti(OR₃)₄. The titanium alkoxides may comprise: titanium n-butoxide Ti(OBuⁿ), titanium isobutoxide Ti(OBuⁱ)₄, titanium tert-butoxide Ti(OBu^{t})₄, titanium isopropoxide Ti(OPrⁱ)₄, titanium n-propoxide Ti(OPrⁿ)₄, titanium ethoxide Ti(OEt)₄, or other titanium alkoxides. Si(OR₂)₃OH alcohol solution is added dropwise to the stirred N equivalent Ti(OR₃)₄ titanium alkoxide to obtain (OR₂)₃SiOT[i](OR₃)₃ and (N-1) equivalent Ti(OR₃)₄ alcohol solution. Then, N equivalent of H₂O/R₁OH (1:2) mixed solution, which is adjusted to pH=1.0-2.0 with inorganic acid such as hydrochloric acid HCl or nitric acid HNO₃, etc., is added dropwise into stirred alcohol solution of (OR₂)₃SiOT(OR₃)₃ and 3Ti(OR₃)₄, which is hydrolyzed by (OR₂)₃SiOT(OR₃)₃ and (N-1) equivalent Ti(OR₃)₄.

For the preparation of SiO₂ sol, silicon alkoxide Si(OR₂)₄ is added to the ethanol EtOH. The silicon alkoxide may comprise silicon ethoxide Si(OEt)₄, silicon methoxide Si(OMe)₄, silicon propoxide Si(OPr)₄, silicon isopropoxide Si (OPrⁱ)₄, or other silicon alkoxides. After stirring, silicon alkoxide solution is formed. A mixture of H₂O:R₁OH=1:2 is prepared and is adjusted to pH=1.0-2.0 with inorganic acid such as hydrochloric acid HCl or nitric acid HNO₃. Thereafter, 1.0-2.0 equivalents of H₂O/R₁OH solution (pH=1.0-2.0) is added dropwise to 1 equivalent of stirred silicon alkoxide solution.

For the preparation of TiO₂ sol, titanium alkoxide Ti(OR₃)₄ is added to the ethanol EtOH. After stirring, titanium alkoxide solution is formed. The titanium alkoxides may comprise: titanium n-butoxide Ti(OBuⁿ)₄, titanium isobutoxide Ti(OBuⁱ)₄, titanium tert-butoxide Ti(OBu^{t})₄, titanium isopropoxide Ti(OPrⁱ)₄, titanium n-propoxide Ti(OPrⁿ)₄, titanium ethoxide Ti(OEt)₄, or other titanium alkoxides. A mixture of H₂O:R₁OH=1:2 is prepared and is adjusted to pH=1.0-2.0 with inorganic acid such as hydrochloric acid HCl or nitric acid HNO₃. Thereafter, 1.0-2.0 equivalents of H₂O/R₁OH solution (pH=1.0-2.0) is added dropwise to 1 equivalent of stirred titanium alkoxide solution.

The prepared TiO₂ sol, SiO₂ sol and TiO₂—SiO₂ sol are used to perform double-sided dip-coating of a glass substrate. First, the TiO₂—SiO₂ sol coating is performed, and the coated glass substrate is baked at 150-250° C. for 10 minutes so as to form TiO₂—SiO₂/Glass/TiO₂—SiO₂ coated glass. Then, SiO₂ sol coating is performed, and the coated glass substrate is baked at 150-250° C. so as to form SiO₂/TiO₂—SiO₂/Glass/TiO₂—SiO₂/SiO₂ coated glass. Subsequently, TiO₂ sol coating is performed, and the coated glass substrate is baked at 150-250° C. for 10 minutes so as to form TiO₂/SiO₂/TiO₂—SiO₂/Glass/TiO₂—SiO₂/SiO₂/TiO₂ coated glass, which is then annealed at 400-600° C. for one hour. Then, the coated and annealed glass substrate is cut and thermal bent to form automobile rearview blue mirrors.

Taking the automobile rearview blue mirror as an example, the thickness of each layer of the TiO₂, SiO₂, and TiO₂—SiO₂ coatings may be adjusted so that the peak of the reflected light is at blue spectral region. For example, the thickness of the TiO₂ coating=blue light wavelength/(4×TiO₂ coating refractive index), the thickness of the SiO₂ coating=blue light wavelength/(4×SiO₂ coating refractive index), and the thickness of the TiO₂—SiO₂ coating=blue light wavelength/(4×TiO₂ —SiO₂ coating refractive index). All of the three coatings of TiO₂, SiO₂, and TiO₂—SiO₂ have the peak of the reflected light at the blue spectral region. Therefore, the headlight of a following vehicle reflected by the mirror is mainly blue, so it is called blue mirror.

The invention method for manufacturing the hydrophilic, self-cleaning photocatalyst automobile rearview blue mirror can be divided into sol preparation and photocatalyst automobile rearview blue mirror manufacturing. The sol preparation comprises TiO₂ sol, SiO₂ sol and TiO₂—SiO₂ sol as described above. The preparation of anatase TiO₂ preform sol is the crucial part. For example, titanium butoxide Ti(OBuⁿ)₄ is added in ethanol, stirred and mixed into a titanium alkoxide solution. H₂O/R₁OH solution is prepared and is adjusted to pH=0.5 with inorganic acid such as nitric acid HNO₃. Thereafter, 1.52.0 equivalents of H₂O/R₁OH solution is added dropwise to stirred titanium alkoxide solution to pH=0.11.0. The anatase TiO₂ preform sol was prepared. After coating, an anneal at 400-600° C. is performed, and the structure and effect of anatase TiO₂ photocatalyst are produced on the coated surface.

The photocatalyst rearview blue mirror for automobiles is manufactured by using TiO₂—SiO₂ sol, SiO₂ sol and anatase TiO₂ preform sol on the glass substrate for sol optical coating. The required blue light reflection intensity can be selected and the required optical coating can be designed according to the type and spectrum of the car headlight. For example, the compositions of the first layer of TiO₂—SiO₂ sol on the glass substrate may be replaced with TiO₂ sol, 4TiO₂—SiO₂ sol, 3TiO₂—SiO₂ sol, 2TiO₂—SiO₂ sol and TiO₂—SiO₂ sol coating. Then, SiO₂ sol coating and anatase TiO₂ preform sol coating are performed. The coated glass is baked and annealed to make a photocatalyst blue mirror. By providing different compositions of the first layer of TiO₂—SiO₂ sol, the blue light reflection intensity can be adjusted. Five types of the coating material structures are listed as follows:
1. anatase TiO₂/SiO₂/TiO₂—SiO₂/Glass/TiO₂—SiO₂/SiO₂/anatase TiO₂ blue mirror
2. anatase TiO₂/SiO₂/2TiO₂—SiO₂/Glass/2TiO₂—SiO₂/SiO₂/anatase TiO₂ blue mirror
3. anatase TiO₂/SiO₂/3TiO₂—SiO₂/Glass/3TiO₂—SiO₂/SiO₂/anatase TiO₂ blue mirror
4. anatase TiO₂/SiO₂/4TiO₂—SiO₂/Glass/4TiO₂—SiO₂/SiO₂/anatase TiO₂ blue mirror
5. anatase TiO₂/SiO₂/TiO₂/Glass/TiO₂/SiO₂/anatase TiO₂ blue mirror

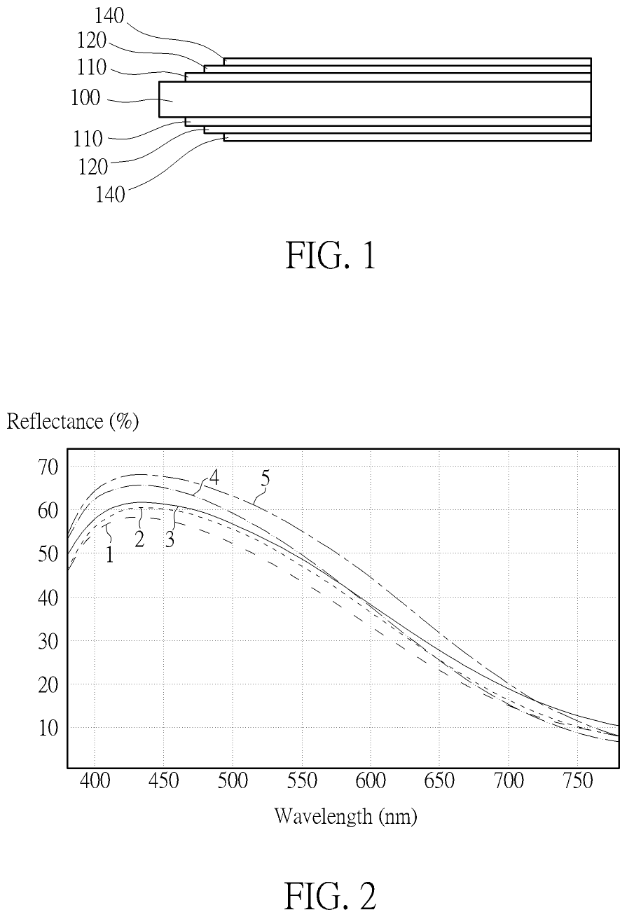

As shown in FIG. 2, the reflection spectrum of the various beam splitter coating structures 1, 2, 3, 4, and 5 have blue light reflectance of 55%, 58%, 61%, 63%, and 65%, respectively, at 440 nm. According to the change of spectrum of various car headlights, appropriate car rearview mirror with suitable blue light reflectance can be chosen. Such beam splitter can be used as an interior rearview mirror and has anti-glare effect. Such beam splitter can be used on both sides of the car and can provide anti-fog, hydrophilic self-cleaning effects, in addition to anti-glare effect.

### EXAMPLES

Examples of preparing sol for making self-cleaning beam splitter are provided. The exemplary methods of preparing TiO₂ sol, 4TiO₂—SiO₂ sol, 3TiO₂—SiO₂ sol, 2TiO₂—SiO₂ sol and TiO₂—SiO₂ sol are illustrated as follows.

### Preparation of 4TiO₂—SiO₂ Sol (TS-41)

Taking TS-41 as an example; the content ratio of TiO₂: SiO₂ in the sol is 4:1. 1.0 mole tetraethoxysilane (TEOS) is added in ethanol EtOH, mixed by stirring so as to form silicon alkoxide solution. 1.0 mole H₂O is mixed with 2.0 mole alcohol, and added dropwise into the silicon alkoxide solution to obtain an ethanol solution of Si(OEt)₃OH. Then, 1.0 mole of Si(OEt)₃OH in ethanol solution was stirred and dropped into 4.0 mole of Ti(OBuⁿ)₄ to obtain (EtO)₃ SiOTi(OBuₙ)₃ and 3Ti(OBuⁿ)₄ alcohol solution. Then, 3.0 mole water/alcohol mixture (H₂O/EtOH=1/2), titrate with concentrated HNO₃ to adjust the pH to 1.5, is added to stirred (EtO)₃SiOTi(OBuⁿ)₃ and 3Ti(OBuⁿ)₄ alcohol solution, so as to perform hydrolysis and condensation of (EtO)₃SiOTi(OBuⁿ)₃ and 3Ti(OBuⁿ)₄, thereby form 4TiO₂—SiO₂ sol, represented by the following formula:

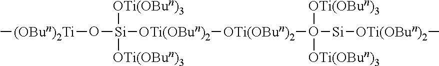

### Preparation of 3TiO₂—SiO₂ Sol (TS-31)

Taking TS-31 as an example; the content ratio of TiO₂: SiO₂ in the sol is 3:1. 1.0 mole tetraethoxysilane is added in ethanol EtOH, mixed by stirring so as to form silicon alkoxide solution. 1.0 mole H₂O is mixed with 2.0 mole alcohol, and added dropwise into the silicon alkoxide solution to obtain an ethanol solution of Si(OEt)₃OH. Then, 1.0 mole of Si(OEt)₃OH in ethanol solution was stirred and dropped into 3.0 mole of Ti(OBuⁿ)₄ to obtain (EtO)₃SiOT(OBuⁿ)₃ and 2Ti(OBuⁿ)₄ alcohol solution. Then, 2.0 mole water/alcohol mixture (H₂O/EtOH=1/2), titrate with concentrated HNO₃ to adjust the pH to 1.5, is added to stirred (EtO)₃SiOTi(OBuⁿ)₃ and 2Ti(OBuⁿ)₄ alcohol solution, so as to perform hydrolysis and condensation of (EtO)₃SiOT(OBuⁿ)₃ and 2Ti(OBuⁿ)₄, thereby form 3TiO₂—SiO₂ sol, represented by the following formula:

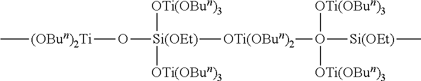

### Preparation of 2TiO₂—SiO₂ Sol (TS-21)

Taking TS-21 as an example; the content ratio of TiO₂: SiO₂ in the sol is 2:1. 1.0 mole tetraethoxysilane is added in ethanol EtOH, mixed by stirring so as to form silicon alkoxide solution. 1.0 mole H₂O is mixed with 2.0 mole alcohol, and added dropwise into the silicon alkoxide solution to obtain an ethanol solution of Si(OEt)₃OH. Then, 1.0 mole of Si(OEt)₃OH in ethanol solution was stirred and dropped into 2.0 mole of Ti(OBuⁿ)₄ to obtain (EtO)₃SiOTi(OBuⁿ)₃ and Ti(OBuⁿ)₄ alcohol solution. Then, 1.0 mole water/alcohol mixture (H₂O/EtOH=1/2), titrate with concentrated HNO₃ to adjust the pH to 1.5, is added to stirred (EtO)₃SiOTi(OBuⁿ)₃ and Ti(OBuⁿ)₄ alcohol solution, so as to perform hydrolysis and condensation of (EtO)₃SiOT(OBuⁿ)₃ and Ti(OBuⁿ)₄, thereby form 2TiO₂—SiO₂ sol, represented by the following formula:

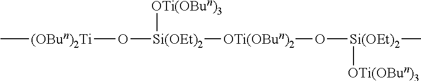

### Preparation of TiO₂—SiO₂ Sol (TS-11)

Taking TS-11 as an example; the content ratio of TiO₂: SiO₂ in the sol is 1:1. 1.0 mole tetraethoxysilane is added in ethanol EtOH, mixed by stirring so as to form silicon alkoxide solution. 1.0 mole H₂O is mixed with 2.0 mole alcohol, and added dropwise into the silicon alkoxide solution to obtain an ethanol solution of Si(OEt)₃OH. Then, 1.0 mole of Si(OEt)₃OH in ethanol solution was stirred and dropped into 1.0 mole of Ti(OBuⁿ)₄ to obtain (EtO)₃SiOT(OBuⁿ)₃ alcohol solution. Then, 1.0 mole water/alcohol mixture (H₂O/EtOH=1/2), titrate with concentrated HNO₃ to adjust the pH to 1.5, is added to stirred (EtO)₃SiOTi(OBuⁿ)₃ alcohol solution, so as to perform hydrolysis and condensation of (EtO)₃SiOT(OBuⁿ)₃, thereby form TiO₂—SiO₂ sol, represented by the following formula:

—(OBuⁿ)₂Ti—O—Si(OEt)₂-OTi(OBuⁿ)₂-O—Si(OEt)₂-

### Preparation of SiO₂ Sol (SD-01)

Taking SD-01 as an example, tetraethoxysilane is added in ethanol EtOH, mixed by stirring so as to form silicon alkoxide solution. H₂O is mixed with ethanol EtOH (H₂O/EtOH=1/2), wherein hydrochloric acid is used to adjust the pH. 2.0 moles of H₂O/EtOH solution (pH=1.5) is added in stirred 1.0 mole silicon alkoxide solution.

### Preparation of TiO₂ Sol (TD-01)

Taking TD-01 as an example, Ti(OBuₙ)₄ is added in ethanol EtOH, mixed by stirring so as to form titanium alkoxide solution. H₂O is mixed with ethanol EtOH (H₂O/EtOH=1/2), wherein HNO₃ is used to adjust the pH. 1.0 moles of H₂O/EtOH solution (pH=1.5) is added in stirred 1.0 mole titanium alkoxide solution, stirred to perform hydrolysis and condensation reaction, thereby forming TiO₂ sol.

### Preparation of anatase TiO₂ preform Sol (TD-02)

Taking TD-02 as an example, 1.0 mole Ti(OBuⁿ)₄ is added to 1 liter of ethanol EtOH, stirred to mix into titanium alkoxide solution. Concentrated nitric acid is used to adjust pH of 1.5-1.8 moles of aqueous solution (H₂O/EtOH=1/2) to pH=0.5. The aqueous solution is added dropwise into the titanium alkoxide solution, stirred for hydrolysis and condensation reaction, thereby forming anatase TiO₂ preform sol.

### Examples of Making Self-Cleaning Beam Splitter by Sol Coating Process

The first optical coating of glass substrate by TiO₂, 4TiO₂—SiO₂, 3TiO₂—SiO₂, 2TiO₂—SiO₂, and TiO₂—SiO₂ sol, respectively, followed by SiO₂ sol coating, then anatase TiO₂ preform sol coating. The process flow of making a photocatalyst self-cleaning beam splitter is as follows.

The fabrication process of anatase TiO₂/SiO₂/TiO₂—SiO₂/Glass/TiO₂—SiO₂/SiO₂/anatase TiO₂ blue mirror is listed as follows.

Glass→TS-11 sol coating>(TiO₂—SiO₂)g/Glass/(TiO₂—SiO₂)g→200° C., 10 mins→(TiO₂—SiO₂)b/Glass/(TiO₂—SiO₂)b→DS-01 sol coating→(SiO₂)g(TiO₂—SiO₂)b/Glass/(TiO₂—SiO₂)b(SiO₂)g→200° C., 10 mins→(SiO₂)b/(TiO₂—SiO₂)b/Glass/(TiO₂—SiO₂)b/(SiO₂)b→TD-02 sol coating→(anatase TiO₂ preform)g/(SiO₂)b/(TiO₂—SiO₂)b/Glass/(TiO₂—SiO₂)b/(SiO₂)b/(anatase TiO₂ preform)g→500° C., 1 Hr→anatase TiO₂/SiO₂/TiO₂—SiO₂/Glass/TiO₂—SiO₂/SiO₂/anatase TiO₂

The fabrication process of anatase TiO₂/SiO₂/2TiO₂—SiO₂/Glass/2TiO₂—SiO₂/SiO₂/anatase TiO₂ blue mirror is listed as follows.

Glass→TS-21 sol coating→(2TiO₂—SiO₂)g/Glass/(2TiO₂—SiO₂)g→200° C., 10 mins→(2TiO₂—SiO₂)b/Glass/(2TiO₂—SiO₂)b→DS-01 sol coating (SiO₂)g(2TiO₂—SiO₂)b/Glass/(2TiO₂—SiO₂)b(SiO₂)g→200° C., 10 mins→(SiO₂)b/(2TiO₂—SiO₂)b/Glass/(2TiO₂—SiO₂)b/(SiO₂)b→TD-02 sol coating→(anatase TiO₂ preform)g/(SiO₂)b/(2TiO₂—SiO₂)b/Glass/(2TiO₂—SiO₂)b/(SiO₂)b/(anatase TiO₂ preform)g-500° C., 1 Hr→anatase TiO₂/SiO₂/2TiO₂—SiO₂/Glass/2TiO₂—SiO₂/SiO₂/anatase TiO₂

The fabrication process of anatase TiO₂/SiO₂/3TiO₂—SiO₂/Glass/3TiO₂—SiO₂/SiO₂/anatase TiO₂ blue mirror is listed as follows.

Glass→TS-31 sol coating→(3TiO₂—SiO₂)g/Glass/(3TiO₂—SiO₂)g→200° C., 10 mins→(3TiO₂—SiO₂)b/Glass/(3TiO₂—SiO₂)b→DS-01 sol coating→(SiO₂)g(3TiO₂—SiO₂)b/Glass/(3TiO₂—SiO₂)b(SiO₂)g→200° C., 10 mins→(SiO₂)b/(3TiO₂—SiO₂)b/Glass/(3TiO₂—SiO₂)b/(SiO₂)b→TD-02 sol coating→(anatase TiO₂ preform)g/(SiO₂)b/(2TiO₂—SiO₂)b/Glass/(3TiO₂—SiO₂)b/(SiO₂)b/(anatase TiO₂ preform)g-500° C., 1 Hr→anatase TiO₂/SiO₂/3TiO₂—SiO₂/Glass/3TiO₂—SiO₂/SiO₂/anatase TiO₂

The fabrication process of anatase TiO₂/SiO₂/4TiO₂—SiO₂/Glass/4TiO₂—SiO₂/SiO₂/anatase TiO₂ blue mirror is listed as follows.

Glass>TS-41 sol coating→(4TiO₂—SiO₂)g/Glass/(4TiO₂—SiO₂)g→200° C., 10 mins→(4TiO₂—SiO₂)b/Glass/(4TiO₂—SiO₂)b→DS-01 sol coating→(SiO₂)g(4TiO₂—SiO₂)b/Glass/(4TiO₂—SiO₂)b(SiO₂)g→200° C., 10 mins→(SiO₂)b/(4TiO₂—SiO₂)b/Glass/(4TiO₂—SiO₂)b/(SiO₂)b→TD-02 sol coating→(anatase TiO₂ preform)g/(SiO₂)b/(4TiO₂—SiO₂)b/Glass/(4TiO₂—SiO₂)b/(SiO₂)b/(anatase TiO₂ preform)g-500° C., 1 Hr→anatase TiO₂/SiO₂/4TiO₂—SiO₂/Glass/4TiO₂—SiO₂/SiO₂/anatase TiO₂

The fabrication process of anatase TiO₂/SiO₂/TiO₂/Glass/TiO₂/SiO₂/anatase TiO₂ blue mirror is listed as follows.

Glass→TD-01 sol coating→(TiO₂)g/Glass/(TiO₂)g→200° C., 10 mins→(TiO₂)b/Glass/(TiO₂)b DS-01 sol coating→(SiO₂)g(TiO₂)b/Glass/(TiO₂)b(SiO₂)g→200° C., 10 mins→(SiO₂)b/(TiO₂)b/Glass/(TiO₂)b/(SiO₂)b→TD-02 sol coating→(anatase TiO₂ preform)g/(SiO₂)b/(TiO₂)b/Glass/(TiO₂)b/(SiO₂)b/(anatase TiO₂preform)g→500° C., 1 Hr→anatase TiO₂/SiO₂/TiO₂/Glass/TiO₂/SiO₂/anatase TiO₂

The SiO₂/TiO₂ ratios in the TiO₂—SiO₂ sol such as TD-01, TS-41, TS-31, TS-21 and TS-11 is 0/1, 1/4, 1/3, 1/2 and 1/1, respectively. Double-sided coating of the first layer of sol on the glass substrate is carried out. After baking at 200° C. for 10 minutes in the oven, TiO₂, 4TiO₂—SiO₂, 3TiO₂—SiO₂, 2TiO₂—SiO₂, or TiO₂—SiO₂ coated glass is obtained for adjusting the reflectance. The thickness of the sol coating may be adjusted to the desired optical thickness by setting the glass withdrawal speed. The second layer of SiO₂ sol (SD-01) double-sided coating is then performed. The coated glass is then baked in the oven at 150-250° C. for 10 minutes. The third layer Anatase TiO₂ Preform sol (TD-02) double-sided coating is then performed. The coated glass is then annealed at high temperatures of 400-600° C., and then cut and bent to make blue mirror.

To make the photocatalyst blue mirrors for the automobile rearview mirrors, Ti(OBuⁿ)₄ is added in ethanol, stirred to mix into titanium alkoxide solution, and added dropwise with 1.8 equivalents of H₂O/R₁OH solution, which is adjusted with concentrated nitric acid HNO₃ to pH=0.5. The aqueous solution was stirred and dropped into the titanium alkoxide solution to prepare anatase TiO₂ preform sol. The anatase TiO₂ preform sol coating is carried out on SiO₂/TiO₂—SiO₂/Glass/TiO₂—SiO₂/SiO₂ coated glass, which is annealed to make anatase TiO₂/SiO₂/TiO₂—SiO₂/Glass/TiO₂—SiO₂/SiO₂/anatase TiO₂ photocatalyst blue mirror. The interior rearview mirror made by such beam splitter can provide anti-glare effect in the car. The exterior rearview mirror made by such beam splitter can provide anti-glare effect for both sides of the car, and anti-fog, hydrophilic self-cleaning effects.

### Fabrication of Photocatalyst Blue Mirror for Automobile Rearview Mirror

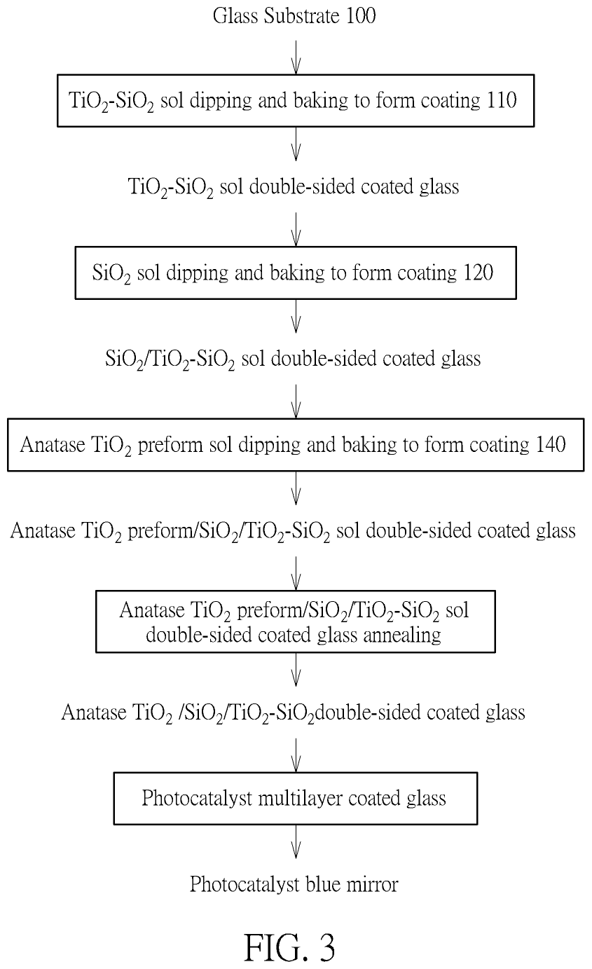

Anatase TiO₂, SiO₂, TiO₂—SiO₂ sol optical coating technology is applied on the glass by sol coating, as shown in FIG. 3. Taking the blue mirror as the target product and the coating thickness of each layer is controlled. The thickness of each layer of the TiO₂, SiO₂, and TiO₂—SiO₂ coatings may be adjusted so that the peak of the reflected light is at 440 nm. For example, the thickness of the TiO₂ coating=blue light wavelength/(4×TiO₂ coating refractive index), the thickness of the SiO₂ coating t=blue light wavelength/(4×SiO₂ coating refractive index), and the thickness of the TiO₂—SiO₂=blue light wavelength/(4×(TiO₂—SiO₂) coating refractive index). All of the three coatings of TiO₂, SiO₂, and TiO₂—SiO₂ have the peak of the reflected light at the blue spectral region. Therefore, the headlight of a following vehicle reflected by the mirror is mainly blue, so it is called blue mirror.

The optical efficiency of the present invention product is represented by a blue mirror, and the function is represented by the photocatalyst. The function and durability test of the photocatalyst are carried out according to the anatase TiO₂/SiO₂/TiO₂/Glass/TiO₂/SiO₂ anatase TiO₂ blue mirror as the representative. Some characteristics of the blue mirror are listed in Table 1. (1) Hydrophilic contact angle: UVA 365 nm irradiation for 24 hours, contact angle <10°; dark place>48 hours, contact angle <30°; verified according to TN-004 nano-photocatalyst anti-fouling ceramic tile specification. (2) Fading rate: UVA 365 nm irradiation for 3 hours, methylene blue decomposition activity>7.0 nmole/(L×min); verified according to TN-031 nanophotocatalyst self-cleaning coating specification. (3) Durability: including salt water resistance, acid resistance and alkaline resistance tests, the hydrophilicity is more than 70% of the original function, the original hydrophilic contact angle is less than 10°, and the hydrophilic contact angle after the test is less than 15 verified according to TN-004

### Blue Mirror Durability

A. Salt water resistance test: After soaking the blue mirror in NaCl brine (3%) for 96 hours, wash it and dry it, UVA 365 nm irradiation for 24 hours, hydrophilic contact angle <15°.

B. Acid resistance test; after soaking the blue mirror in H₂SO₄ sulfuric acid aqueous solution (5%) for 24 hours, wash it and dry it, UVA 365 nm irradiation for 24 hours, hydrophilic contact angle <15°.

C. Alkaline resistance test; after soaking the blue mirror in sodium carbonate (Na₂CO₃) aqueous solution (5%) for 24 hours, wash it and dry it, UVA 365 nm irradiation for 24 hours, hydrophilic contact angle <15°.

Verification according to TN-004 Nano Photocatalyst Self-cleaning Coating Specification.

TABLE 1
Test results of photocatalyst blue mirror

| Blue | | | | Durability | Durability | Durability |
|---|---|---|---|---|---|---|
| mirror | | Dark | methylene | Salt water | Acid | Alkaline |
| structure | UVA24Hr | 48 Hr | blue | resistance | resistance | resistance |
| | Water | Water | decomposition | UVA24Hr | UVA24Hr | UVA24Hr |
| | contact | contact | activity | | | |
| | angle | angle | | | | |
| | | | | Water | Water | Water |
| | | | | contact | contact | contact |
| | | | | angle | angle | angle |
| TA/S/TD1/G/ | 6.65° | 18.43° | 7.02 | 6.56° | 6.61° | 6.28° |
| blue mirror | | | | | | |
| nanoMark | TN-004 | TN-004 | TN-031 | TN-004 | TN-004 | TN-004 |
| (Taiwan) | | | | | | |

TA/S/TD1/G/blue mirror = anatase TiO₂ /SiO₂/TiO₂/Glass/TiO₂/SiO₂/ anatase TiO₂ coated glass

The photocatalyst blue mirror developed by this sol optical coating technology has a physical hardness of 6H. Cross-cut adhesion test without falling off is 5B. Abrasion resistance test; sponge test, rubbing back and forth 2000 times, water drop contact angle 5.61°. Scrub resistance test; scrubbing machine back and forth 15 times, water drop contact angle 8.15°.

The product developed by this sol optical coating technology is not limited to the photocatalyst blue mirrors. If the application of sol optical coating products is expanded, the sol coating can be developed to make photocatalyst multilayer reflective glass and produce near infrared, red, orange, yellow, green, blue, purple or ultraviolet light strong reflective optical coated glass. Such glass with photocatalyst self-cleaning effect is suited for indoor or outdoor windows, mirrors, colored reflective self-cleaning glass, and can also be used in vehicles, ships, and aircrafts.

To sum up, a method for fabricating a beam splitter with photocatalytic coating is disclosed. First, a TiO₂—SiO₂ sol, a SiO₂ sol, and an anatase TiO₂ preform sol are prepared. A glass substrate having two opposite surfaces is provided. The two opposite surfaces of the glass substrate is coated with the TiO₂—SiO₂ sol, the SiO₂ sol, and the anatase TiO₂ preform sol by the dip-coating method, thereby forming a coated glass substrate with a multi-layer optical coating on each of the two opposite surfaces. The multi-layer optical coating comprises a TiO₂—SiO₂ coating, a SiO₂ coating, and an anatase TiO₂ preform coating. The coated glass substrate is subjected to an anneal process. The coated glass substrate is cut, thereby forming the beam splitter with photocatalytic coating.

According to some embodiments, the dip-coating the two opposite surfaces of the glass substrate comprises: immersing the glass substrate in the TiO₂—SiO₂ sol, the SiO₂ sol, [and] the anatase TiO₂ preform sol; withdrawing the glass substrate from the TiO₂—SiO₂ sol, the SiO₂ sol, or the anatase TiO₂ preform sol at a constant withdrawal speed as requirements and baking the glass substrate at 150-250° C.

According to some embodiments, the anneal process is performed at 400-600° C.

According to some embodiments, the multi-layer optical coating has reflection at blue spectral region.

According to some embodiments, a thickness of the TiO₂ coating=blue light wavelength/(4×TiO₂ coating refractive index), a thickness of the SiO₂ coating=blue light wavelength/(4×SiO₂ coating refractive index), and a thickness of the TiO₂—SiO₂ coating=blue light wavelength/(4×TiO₂ —SiO₂ coating refractive index).

According to some embodiments, TiO₂—SiO₂ sol, the SiO₂ sol and the anatase TiO₂ preform sol use titanium alkoxide or silicon alkoxide as a precursor, and wherein the TiO₂—SiO₂ sol, the SiO₂ sol and the anatase TiO₂ preform sol are prepared by hydrolysis, condensation and peptization in alcohol solvent.

According to some embodiments, the TiO₂—SiO₂ sol, the SiO₂ sol and the anatase TiO₂ preform sol are prepared to impart anti-glare effect to an automobile rearview mirror made from the beam splitter, which avoids glare from a following vehicle headlight to a driver, by adjusting a reflectance of the beam splitter, and by adjusting a solid content ratio of the TiO₂—SiO₂ sol, the SiO₂ sol and the anatase TiO₂ preform sol between 1-0.

According to some embodiments, a SiO₂/TiO₂ solid content ratio in the TiO₂—SiO₂ sol ranges between 1-0, and wherein the beam splitter reflects blue light at 440 nm and a reflectance thereof is between 55-65%.

According to some embodiments, an ambient air temperature and humidity is controlled and the withdrawal speed is adjusted according to a solid content of each of aid TiO₂—SiO₂ sol, the SiO₂ sol and the anatase TiO₂ preform sol, and wherein the glass substrate is baked at 150-250° C. for 10 minutes, and annealed at 400-600° C. for 1.0 hour, such that a peak of a reflective spectrum of the multi-layer optical coating is at 440 nm.

According to some embodiments, a peak of a reflection spectrum of an optical coating of each of the TiO₂—SiO₂ sol, the SiO₂ sol and the anatase TiO₂ preform sol is at 440 nm after baking and annealing, and then each sol is laminated and coated according to this condition to make anatase TiO₂/SiO₂/SiO₂—TiO₂/glass substrate/SiO₂—TiO₂/SiO₂/anatase TiO₂ blue mirror with a blue light reflectance at 440 nm between 55-65%.

According to some embodiments, the anatase TiO₂ preform sol uses titanium alkoxide as a precursor, hydrolyzed and condensed in ethanol, peptized by HNO₃, so as to form the anatase TiO₂ preform sol, and wherein an anatase TiO₂ coating formed by the dip-coating, baking and annealing has photocatalytic, hydrophilic, and self-cleaning effects.

According to some embodiments, the anatase TiO₂/SiO₂/SiO₂—TiO₂/glass substrate/SiO₂—TiO₂/SiO₂/anatase TiO₂ blue mirror has the anatase TiO₂ coating on its outer surface, so under ultraviolet rays of sunlight, it produces photocatalyst effects comprising hydrophilic phenomenon, chemical redox reaction, sterilization, mildew prevention, self-cleaning, and decontamination.

Those skilled in the art will readily observe that numerous modifications and alterations of the device and method may be made while retaining the teachings of the invention. Accordingly, the above disclosure should not be constrained as limited only by the metes and bounds of the appended claims.

Because, the sol-gel coating with TiO₂—SiO₂ sol, the SiO₂ sol and the anatase TiO₂ preform sol, for the multi-layer optical coating to make photocatalysis blue mirror can be apply on other sol-gel optical coating: such as high-reflection, low-reflection, color filter with photocatalysis coating on surface. Those photocatalyst optical coating glass can be applied on building glass and ship glass with self-cleaning, hydrophilic, chemical redox reaction, sterilization, mildew prevention etc.

What is claimed is:

1. A method for fabricating a beam splitter with photocatalytic coating, comprising:
preparing a TiO₂—SiO₂ sol, a SiO₂ sol, and an anatase TiO₂ preform sol;
providing a glass substrate having two opposite surfaces;
dip-coating said two opposite surfaces of said glass substrate with said TiO₂—SiO₂ sol, said SiO₂ sol, and said anatase TiO₂ preform sol, thereby forming a coated glass substrate with a multi-layer optical coating on each of said two opposite surfaces, wherein said multi-layer optical coating comprises a TiO₂—SiO₂ coating, a SiO₂ coating, and an anatase TiO₂ preform coating;
subjecting said coated glass substrate to an anneal process; and
cutting said coated glass substrate, thereby forming said beam splitter with photocatalytic coating.

2. The method according to claim 1, wherein said dip-coating said two opposite surfaces of said glass substrate comprises:
immersing said glass substrate in said TiO₂—SiO₂ sol, said SiO₂ sol, or said anatase TiO₂ preform sol;
withdrawing said glass substrate from said TiO₂—SiO₂ sol, said SiO₂ sol, or said anatase TiO₂ preform sol at a constant withdrawal speed; and
baking said glass substrate at 150-250° C.

3. The method according to claim 1, wherein said anneal process is performed at 400-600° C.

4. The method according to claim 1, wherein said multi-layer optical coating has refection at blue spectral region.

5. The method according to claim 1, wherein a thickness of said TiO₂ coating=blue light wavelength/(4×TiO₂ coating refractive index), a thickness of said SiO₂ coating=blue light wavelength/(4×SiO₂ coating refractive index), and a thickness of said TiO₂—SiO₂ coating=blue light wavelength/(4×TiO₂ —SiO₂ coating refractive index).

6. The method according to claim 1, wherein said TiO₂—SiO₂ sol, said SiO₂ sol and said anatase TiO₂ preform sol use titanium alkoxide and/or silicon alkoxide as a precursor, and wherein said TiO₂—SiO₂ sol, said SiO₂ sol and said anatase TiO₂ preform sol are prepared by hydrolysis, condensation and peptization in alcohol solvent.

7. The method according to claim 1, wherein said TiO₂—SiO₂ sol, said SiO₂ sol and said anatase TiO₂ preform sol are prepared to impart anti-glare effect to an automobile rearview mirror made from said beam splitter, which avoids glare from a following vehicle headlight to a driver, by adjusting a reflectance of said beam splitter, and by adjusting a solid content ratio of said TiO₂—SiO₂ sol, said SiO₂ sol and said anatase TiO₂ preform sol between 1-0.

8. The method according to claim 1, wherein a SiO₂/TiO₂ solid content ratio in said TiO₂—SiO₂ sol ranges between 1-0, and wherein said beam splitter reflects blue light at 440 nm and an reflectance thereof is between 55-65%.

9. The method according to claim 2, wherein an ambient air temperature and humidity is controlled and said withdrawal speed is adjusted according to a solid content of each of aid TiO₂—SiO₂ sol, said SiO₂ sol and said anatase TiO₂ preform sol, and wherein said glass substrate is baked at 150-250° C. for 10 minutes, and annealed at 400-600° C. for 1.0 hour, such that a peak of a reflective spectrum of said multi-layer optical coating is at 440 nm.

10. The method according to claim 1, wherein a peak of a reflection spectrum of an optical coating of each of said TiO₂—SiO₂ sol, said SiO₂ sol and said anatase TiO₂ preform sol is at 440 nm after baking and annealing, and then each sol is laminated and coated according to this condition to make anatase TiO₂/SiO₂/SiO₂—TiO₂/glass substrate/SiO₂—TiO₂/SiO₂/anatase TiO₂ blue mirror with a blue light reflectance at 440 nm between 55-65%.

11. The method according to claim 10, wherein said anatase TiO₂ preform sol uses titanium alkoxide as a precursor, hydrolyzed and condensed in ethanol, peptized by HNO₃, so as to form said anatase TiO₂ preform sol, and wherein an anatase TiO₂ coating formed by said dip-coating, baking and annealing has photocatalytic, hydrophilic, and self-cleaning effects.

12. The method according to claim 11, wherein said anatase TiO₂/SiO₂/SiO₂—TiO₂/glass substrate/SiO₂—TiO₂/SiO₂/anatase TiO₂ blue mirror has said anatase TiO₂ coating on its outer surface, so under ultraviolet rays of sunlight, it produces photocatalyst effects comprising hydrophilic phenomenon, chemical redox reaction, sterilization, mildew prevention, self-cleaning, and decontamination.
